(19) United States
(12) Patent Application Publication
(10) Pub. No.: US 2011/0218649 A1
(43) Pub. Date: Sep. 8, 2011

(54) METHOD AND APPARATUS FOR AT LEAST ONE DEVICE CONTROL INSTRUCTION

(76) Inventors: Stefan Ast, Munchen (DE); Thomas Birkhölzer, Radolfzell (DE); Christoph Dickmann, Nurnberg (DE)

(21) Appl. No.: 12/719,096

(22) Filed: Mar. 8, 2010

(51) Int. Cl. G05B 11/01

(52) U.S. Cl. 700/12

(57) ABSTRACT

A method and an apparatus provide a quantitative process simulation model with systematic search and optimization techniques to automatically find and compare improvement strategies and especially provide for inspecting at least one device control instruction. Input parameters are transformed into output parameters, while a performance value is measured and based on said measurement appropriate device control instructions, which are used for transforming the input parameters into output parameters, are output. Application can be found in several scenarios related to process engineering, process optimization and especially optimizing performance values for operating a device.

### TECHNICAL FIELD

The present invention is directed to a method and a respective apparatus for evaluating multiple different approaches to achieve a predefined set of goals and is especially directed to a method and a respective apparatus for inspecting at least one device control instruction. The present invention is furthermore directed to a computer program product being adapted to perform the method for inspecting at least one device control instruction and a respective data carrier, which stores said computer program.

### BACKGROUND

Machines and devices typically comprise a variety of components, which interact for providing certain functionality. These machines and devices may be operated in sensitive environments, for instance in a power plant. It is therefore required that such devices and machines operate fault robust and reliable. One single failure of a specific component being comprised in a sensitive machine may lead to several other failures, damages and even a dysfunction of a complete system. It can therefore be of special importance to simulate the operation and the provision of certain functionality for assuring that the requested functionality is provided without any difficulty.

Because of an increased complexity of devices and machines and especially of a variety of comprised components being manufactured at different firms, it may not be possible for a technician to evaluate the functioning of such devices and machines manually. Therefore several approaches are known for reading out certain parameters of a machine and furthermore to evaluate them according to provided metrics. This can be performed by manually connecting an evaluation unit with a control unit, for instance of a car, and requesting or measuring certain status parameters.

It may be the case that a device has to be improved according to an improvement strategy comprising several improvement actions. It can be necessary not only to evaluate the impact of each of the single improvement actions, but to apply several improvement actions as a whole and to determine the overall output of the application of said improvement actions. These evaluations can be very time consuming and labour-intense. In case that improvement actions are performed manually it may happen that unreliable results are delivered because of a fault of a technician.

Because the devices and machines, which have to be evaluated, might operate in sensitive infrastructures it may not be feasible to perform test runs on said devices and machines, as they may have to be switched-off for accomplishing test runs. Furthermore, it may not be possible to switch-off these devices and machines as they are operated for instance in an assembly line, which would result in a total stand still of this assembly line. Furthermore, it is possible that an evaluation of a provided functionality is required with regard to processes. It can therefore be necessary to simulate an operation of control commands controlling a process.

Control commands often replace hardware in realizing much of the functionality provided by complex systems, e.g. in the medical device industry. The increased complexity of software products, distributed production processes and globally operating organizations lead to higher risks for failures and interruptions during software development. Planning, streamlining, managing and controlling localized or distributed software production are essential tasks of companies that build much of their business on the creation or integration of software.

The control of such a system, i.e. the management of a software organization, requires carefully balanced strategies instead of simple recipes. The various activities of software production depend on each other and form a complex system of relations and dynamics. The experience from promoting software engineering practices often reveals an insufficient consideration or appreciation of the overall system behaviour and complexity by stakeholders and practitioners: Although the single mechanisms seem to be simple and obvious, the overall effects of actions could not easily be predicted because of the number, non-linearity, and time-dependency of the underlying factors. Limited, local optimizations result in unexpected and even counterintuitive overall outcomes.

Interactive simulation is a known method to build and enhance the comprehension of complex systems by experimenting and experimenting with different scenarios. In this case, it can help to build a management understanding of complex software development and of potential effects of certain strategic decisions. This necessitates that, within the simulation, software development processes are related to goals in a way that improvements or changes to development conditions are reflected in characteristics of the organization's overall performance and goal achievement.

Further known approaches provide metrics for evaluating process improvements, for instance in the domain of software engineering. One of these approaches is the so-called capability maturity model integration, also referred to as CMMI.

Commonly known methods, especially in the domain of evaluating and improving the functioning of devices and machines are typically performed manually, which results in enhanced labour. This operation may be prone to errors, which results in unreliable output. Commonly known methods do not provide a solution to dynamic scenarios in which conditions change and one simulation step depends on results of a former simulation step. It is therefore required to provide an approach for simulating a device according to a flexible and fault robust simulation procedure. Generally an approach is required, which allows for measuring and evaluating performance parameters without having to switch off the device, which has to be evaluated.

In commonly known methods improvement scenarios are only analyzed manually by specifying a set of inputs of a simulation model. Different scenarios can be compared by repeating the performing of this approach with slight changes until the desired goals are reached. Typically, defining, configuring and analyzing these changes need to be done manually.

It is necessary to find efficient process improvement scenarios, for instance approaches which achieve the goals with a minimum of resources and efforts. For a complex organisation with many interdependent process areas influencing various outcomes, this is typically a non trivial task, because there might be multiple different approaches to achieve a predefined set of goals. Therefore, it is necessary to calculate an optimal improvement approach towards a future desired process state starting from a given initial state. Starting from a desired output it is therefore required to inspect several device control instructions, which lead to said predefined output.

### SUMMARY

According to various embodiments, a method and an apparatus can be provided which allows the simulation of different instructions for a device being executed with different configuration.

According to an embodiment, a method for inspecting at least one device control instruction, may comprise the steps of:
transforming at least one provided input parameter into at least one provided output parameter by executing a device control instruction;
evaluating a measured capability value of said device, said capability value describing a performance parameter of said device executing said device control instruction; and
outputting said device control instruction in case a specified evaluation result is determined.

According to a further embodiment, the device control instruction may comprise at least one of a group of instruction specifications, the group comprising: a device control instruction configuration, a parameterization of at least one device control instruction, a formal model, an algorithm, a differential equation, a device specification, a diagram and an alphanumerical device control instruction description technique. According to a further embodiment, evaluating the measured capability value can be performed according to a stored capability evaluation metric. According to a further embodiment, the stored capability evaluation metric may comprise at least one of a group of evaluation functions, the group comprising: a cost function, a penalty function and an evaluation function. According to a further embodiment, the measured capability value can be provided according to at least one of a group of provision techniques, the group comprising: reading out a sensor, reading out a storage unit, estimation of the capability value, approximation of the capability value and calculation of the capability value. According to a further embodiment, at least one of the provided input parameters can be weighted with a weighting factor. According to a further embodiment, the weighting factor may indicate at least one of a group of input features, the group comprising: a relevance of one input parameter that regards at least one further input parameter and a probability of an occurrence of at least one input parameter. According to a further embodiment, at least a selection of the provided input parameters can be adapted before performing the step of transforming at least one provided input parameter into at least one provided output parameter. According to a further embodiment, at least a selection of the provided input parameters can be transformed into the provided at least one output parameter. According to a further embodiment, at least one of a group of parameters may be assigned an alphanumerical value, the group comprising: the at least one provided input parameter and the at least one output parameter. According to a further embodiment, the alphanumerical value can be defined as a function of a numerical interval. According to a further embodiment, the device control instruction may describe at least one of a group of dependencies, the group comprising: a temporal dependency, a structural dependency, a logical dependency, a dependency between at least two units of the device, a dependency between at least two activities of a process definition and a dependency between at least two parameters.

According to an embodiment, an apparatus for inspection of at least one device control instruction, especially for performing the method described above, may comprise:
a transformation unit for transforming at least one provided input parameter into at least one provided output parameter by executing a device control instruction;
an evaluation unit for evaluating a measured capability value of the device, the capability value describing a performance parameter of the device executing the device control instruction; and
an output unit for outputting the device control instruction in case a specified evaluation result is determined.

According to yet another embodiments, a computer program can be adapted to perform the method as described above on a computer.

According to yet another embodiment, a data carrier may store a computer program as described above.

### BRIEF DESCRIPTION OF THE DRAWINGS

FIG. 1 shows a flow diagram of a method for inspecting at least one device control instruction according to an embodiment;

FIG. 2 shows a detailed flow diagram of a method for inspecting at least one device control instruction according to an embodiment;

FIG. 3 shows a block diagram of an apparatus for inspection of at least one device control instruction according to an embodiment; and

FIG. 4 shows a detailed block diagram of an apparatus for inspection of at least one device control instruction according to an embodiment.

In the following same elements are denoted with the same reference signs if not indicated otherwise.

### DETAILED DESCRIPTION

According to various embodiments, a method for inspecting at least one device control instruction, may comprise the following steps:
transforming at least one provided input parameter into at least one provided output parameter by executing a device control instruction;
evaluating a measured capability value of said device, said capability value describing a performance parameter of said device executing said device control instruction; and
outputting said device control instruction in case a specified evaluation result is determined.

A device control instruction can for instance be designed to provide a functionality of said device. It may be the case that such a device control instruction initiates the execution of several other control instructions. Furthermore it is possible to implement the device control instruction as a hardware element, such as a circuit, or as a control command. It may furthermore be of advantage that the at least one device control instruction is part of a set of rules, said set of rules describing a behaviour of a device. The behaviour of a device can for instance be a provided functionality of said device, which is provided by operating said set of rules. Hence, executing at least one device control instruction can be performed by a simulating the execution of said device control instruction.

In case an operation of said device is characterized by several state transitions, performing one device control instruction can lead to a state transition. Hence, such a device may be in a first state and after execution of the device control instruction the device may be characterized by a second state. One can therefore describe a device control instruction by a transformation step, transforming one state of the device into another state of the device. It may furthermore be the case that a device control instruction comprises a differential equation or a software code.

The device control instruction can also be performed as a function of a specific parameterization. Hence, the state transitions are performed as a function of a specific set of configuration parameters, the configuration parameters influencing behaviour of the execution of the device control instruction. It is possible that the device control instructions are adapted according to a set of configuration parameters. Hence, inspecting at least one device control instruction may furthermore comprise inspecting a device control instruction configuration and especially inspecting configuration parameters, which are related to said at least one device control instruction.

Transforming at least one provided input parameter into at least one provided output parameter can be performed by executing control commands and/or by initiating execution of a functionality of the device. It is possible to transform a physical object into another state by executing the device control instruction according to an input parameter, which results in at least one provided output parameter. In case the device, which is operated according to the device control instruction, is arranged along an assembly line one input parameter may describe an action, which is performed on the product being transported along the assembly line, which results in one provided output parameter, which may again describe a state of said product. One can for instance define by an input parameter that a certain pressure is applied on the product being arranged along the assembly line and that furthermore a required output parameter is a demanded measurement of said product. The device control instruction may therefore initiate that the device performs a deformation of the product. Hence, it is possible to create a component for instance of a car by executing the device control instruction as a function of input parameters and provided output parameters. If several device control instructions are suitable for deforming the product, measured capability values can be compared and hence a device control instruction, which is considered most suitable, can be chosen. In this way an appropriate device control instruction is empirically determined by sequential performing deformation actions, comparing performance values and selecting a specific device control instruction. While the device control instruction is executed one can measure in which way the provided output parameter is reached. The result of a measurement during the execution of the device control instruction can be referred to as capability value. The capability value indicates the performance of the device while performing the device control instruction. A performance parameter may for instance be a time interval, being for instance measured in seconds, which is required for transforming the at least one provided input parameter into the at least one provided output parameter.

For evaluating the measured capability value one can apply an evaluation metric. Such an evaluation metric may describe at least one performance parameter and an evaluation result with regard to the performance parameter. For instance a measured performance parameter of five seconds for transforming at least one provided input parameter into at least one provided output parameter can be defined as a performance result of class 5, while the measured performance parameter of one second has a performance of class 3. Hence, it is possible to evaluate the measured capability value and especially the derived performance parameter of the device executing the device control instruction. For measuring the capability value a sensor can be applied, which measures the execution behaviour of the device. This sensor may be designed to measure time, temperature, weight and/or further parameters being suitable for evaluating the execution behaviour of said device while executing said device control instruction. It may be of advantage that the sensor is able to provide an image from which a capability value can be derived.

Outputting said device control instruction can be performed in case a specified evaluation result is determined. Hence, an output metric can be applied to the evaluation result and furthermore it can be detected if a specific device control instruction performs as required. Hence only well performing device control instructions can be output and for instance be post-processed or stored in a storage unit. All other device control instructions, which do not fulfil a specified evaluation result are not output. Hence, an iterative performance of the steps of transforming at least one provided input parameter into at least one provided output parameter and evaluating a measured capability value of the device can be performed iteratively and all device control instructions with a specific evaluation result are stored. In case several device control instructions are inspected a transformation step as well as a evaluation step is performed for each of the device control instructions. Only a selection of the transformed and evaluated device control instructions is stored in a storage device and is hence output as a result.

In an embodiment, the device control instruction comprises at least one of a group of instruction specifications, said group comprising a device control instruction configuration, a parameterization of at least one device control instruction, a formal model, an algorithm, a differential equation, a device specification, a diagram and an alphanumerical device control instruction description technique.

This has the advantage that said at least one device control instruction can be performed according to a variety of techniques and furthermore that not only control commands themselves are inspected, but also a set of configuration parameters can be provided according to which said device control instructions perform.

In yet a further embodiment, evaluating the measured capability value is performed according to a stored capability evaluation metric.

This has the advantage that a predefined set of evaluation rules can be provided, which is able to evaluate control commands as well as a set of configuration parameters, both being comprised in at least one device control instruction. Hence, it is possible to apply evaluation steps after each iteration of the afore-mentioned method and therefore changing evaluation rules dynamically at run time.

In yet a further embodiment the stored capability evaluation metric comprises at least one of a group of evaluation functions, said group comprising a cost function, a penalty function and an evaluation function.

This has the advantage that the capability value can be analyzed and hence evaluated according to several aspects. One may for instance define a cost function, which evaluates a specific interval of values regarding the measured capability value as being of special advantage, while a further interval of capability values may be of disadvantage. Hence, several approaches for a fine grained evaluation of the measured capability value are available.

In yet a further embodiment the measured capability value is provided according to at least one of a group of provision techniques, this group comprising reading out a sensor, reading out a storage unit, estimation of said capability value, approximation of the capability value and calculation of said capability value.

This has the advantage that the capability value can be dynamically measured, for instance by a sensor and/or a further hardware device and especially that further calculation steps can be performed for measuring capability values.

In yet a further embodiment at least one of the provided input parameters is weighted with a weighting factor.

This has the advantage that one can define a weighting factor, which again can be considered by the cost function, the penalty function and/or the evaluation function.

In yet a further embodiment said weighting factor indicates at least one of a group of input features, this group comprising a relevance of one input parameter as regards at least one further input parameter and a probability of an occurrence of at least one input parameter.

This has the advantage that one can consider the impact of input parameters as regards the inspection of the execution of the device control instruction as well as provided output parameters by assigning a relevance to input parameters. Furthermore it is possible to consider occurrence probabilities of output parameters in case input parameters are estimated.

In yet a further embodiment at least a selection of said provided input parameters is adapted before performing the step of transforming at least one provided input parameter into at least one provided output parameter.

This has the advantage that a further selection and/or filtering step is applied for considering only relevant input parameters.

In yet a further embodiment at least a selection of the provided input parameters is transformed into the at least one output parameter.

This has the advantage that input parameters can be fine tuned and/or adapted according to configuration parameters.

In yet a further embodiment at least one of a group of parameters is assigned an alphanumerical value, that group comprising at least one provided input parameter and at least one output parameter.

This has the advantage that also attribute-value parameters be considered, which are assigned alphanumerical values.

In yet a further embodiment the alphanumerical value is defined as a function of a numerical interval.

This has the advantage that not only concrete values can be considered, but also ranges of predefined alphanumerical values can be considered.

In yet a further embodiment the device control instruction describes at least one of a group of dependencies, that group comprising a temporal dependency, a structural dependency, a logical dependency, a dependency between at least two units of said device, a dependency between at least two activities of a process definition and a dependency between at least two parameters.

This has the advantage that the device control instructions can be arranged in a temporal order and can describe structural, logical or any further dependencies.

According to other embodiments, an apparatus for inspection of at least one device control instruction can be provided, especially for accomplishing the afore-mentioned method, that apparatus comprising:

a transformation unit for transforming at least one provided input parameter into at least one provided output parameter by executing a device control instruction;
an evaluation unit for evaluating a measured capability value of the device, that capability value describing a performance parameter of the device executing the device control instruction; and
an output unit for outputting the device control instruction in case a specified evaluation result is determined.

According to further embodiments, a computer program can be adapted to perform the afore-mentioned method on a computer as well as a data carrier, which stores respective computer program.

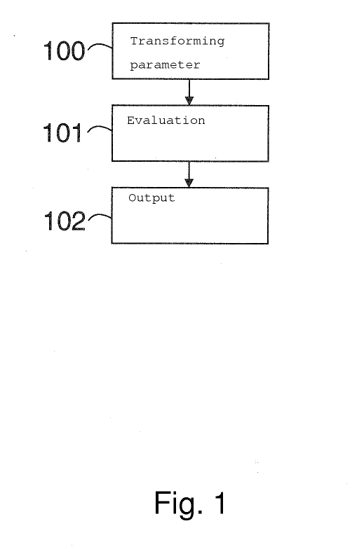

FIG. 1 shows a flow diagram of a method for inspecting at least one device control instruction, comprising the steps of:

In a step 100 transforming at least one provided input parameter into at least one provided output parameter by executing a device control instruction. In a step 101 evaluating a measured capability value of the device, wherein the capability value describes a performance parameter of the device executing the device control instruction. In a further step 102 outputting the device control instruction in case a specified evaluation result is determined.

The afore-mentioned steps may be performed iteratively and/or in a different order and may contain additional sub-steps.

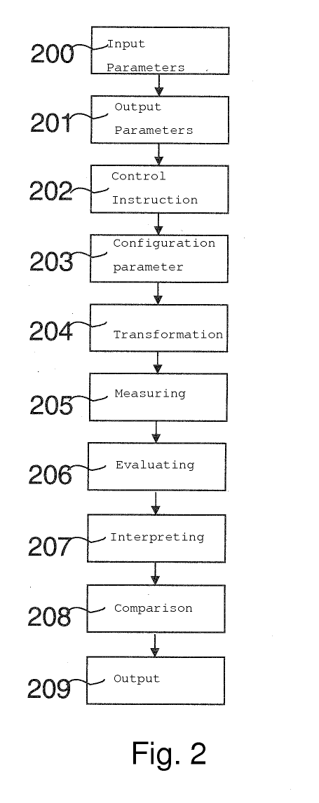

FIG. 2 shows a detailed flow diagram of a method for inspecting at least one device control instruction according to an embodiment comprising the following steps:

In a first step 200 a provision of input parameters is performed. Furthermore output parameters are provided in a subsequent step 201. These parameters may be provided by a data storage unit such as a database. Furthermore, additional sub-steps such as the selection of at least one input parameter out of a variety of input parameters may be accomplished. One may for instance define in step 200 a threshold, which must be exceeded by a value of input parameters. Hence, at least one input parameter is selected in step 200. The provided output parameters of step 201 can define a goal or a target value, which has to be reached by transforming input parameters into output parameters. In further steps of the method a transformation of the provided input parameters of step 200 into output parameters of step 201 may then be performed. In case the provided method for inspection of at least one device control instruction is performed iteratively different input parameters can be provided as a function of further steps described in the following.

In a subsequent step 202 at least one device control instruction is provided. It is possible to configure the provided device control instructions according to provided configuration parameters. These configuration parameters are provided in step 203. The provision of device control instructions can comprise further sub-steps, such as the creation of the device control instructions. For instance the device control instructions can be derived from a set of rules and/or from a formal model simulating a device. In a possible embodiment a model is provided for simulating the device. This model can contain formal rules, such as description logics, for describing the behaviour, e.g. a functionality provided by the device or apparatus.

The provision of configuration parameters in step 203 can comprise reading out a configuration file, being stored on the respective device. Providing configuration parameters can also be performed by interpreting a device specification. This device specification may offer several operation modes of the device. Configuration parameters furthermore serve as input parameters of the provided device control instructions.

After provision of input parameters, output parameters, at least one device control instruction and the configuration parameters in the steps 200 to 203 the at least one provided input parameter is transformed into at least one provided output parameter by executing a device control instruction in step 204. Hence, the device is operated according to the provided device control instruction, which again is executed according to the configuration parameters as provided in step 203. The transformation of the at least one provided input parameter into at least one provided output parameter can be performed by directly operating the device and/or regulating a behaviour of the device. The step 204 can be performed by a device being arranged along an assembly line, which transforms a product, which is characterized by certain input parameters into a product being characterized by certain output parameters. The transformation step can be performed according to different device control instructions, which again can be operated according to different configuration parameters. Hence, it may be necessary, to measure the performance after each execution of a device control instruction, while several device control instructions are performed iteratively.

Measuring of capability values may be performed in step 205. A sensor, being designed to measure capability values, can be arranged along said assembly line for detecting certain parameters describing a transformation step of transforming input parameters into output parameters. One can for instance measure in step 205 how long one device control instruction needs for transforming input parameters into output parameters. The capability value may furthermore indicate whether the device is suitable for transforming the input parameters into the output parameters at all. Hence, the measured capability value may also comprise a Boolean value.

For evaluating the measured capability value an evaluation metric is provided in step 206. The evaluation metric may contain several capability values and respective evaluation results. An evaluation result may for example be 90%, which signifies that the transformation of the input parameters into the output parameters has been accomplished at a degree of 90%. The evaluation metric can furthermore indicate that a specific goal or target value has been reached to a certain degree. A goal can be defined by states, which characterize the device during the execution of a device control instruction. The evaluation of the measured capability value is performed in step 207 by applying the provided evaluation metric in step 206 on the measured capability value, as detected in step 205. The step 207 can comprise interpreting the evaluation metric, i.e. to derive evaluation rules of said provided evaluation metric and/or apply derived rules on the measured capability value. The evaluation result comprises e.g. a Boolean value and/or a percentage to which a specific goal is reached. That goal may be derived from at least one output parameter, as being provided in step 201.

The determined evaluation result step 207 is in a subsequent step 208 compared to a predefined evaluation result. This predefined evaluation result is for instance that a percentage of 80% of a specific goal has to be reached. Hence, in step 208 an evaluated capability value of 70% fails to reach fulfilling a goal of 80%, while an evaluation of the measured capability value of 95% indicates the specified evaluation result has been reached.

In case the specified evaluation result is reached the specific device control instruction along with the respective device control instruction configuration parameters are output. Outputting the device control instructions together with the configuration parameters can include storing these parameters in a database. It is also possible to output the device control instructions to a user, for instance to a user operating that device.

The afore-mentioned steps be performed iteratively and/or in a different order and may comprise further sub-steps.

In a possible embodiment any of the steps 200, 201, 202 and 203 are repeated for providing several input parameters, several output parameters, several device control instructions as well as several configuration parameters. It is furthermore possible to provide the output parameters before providing the input parameters. It may furthermore be of advantage to evaluate several device control instructions along with respective device control instruction configuration parameters and therefore performing steps 202 to step 209 iteratively. Hence, one can provide ten device control instructions in a repeated performance of step 202 and output only three device control instructions in step 209 in case seven provided device control instructions fail to reach a specified evaluation result.

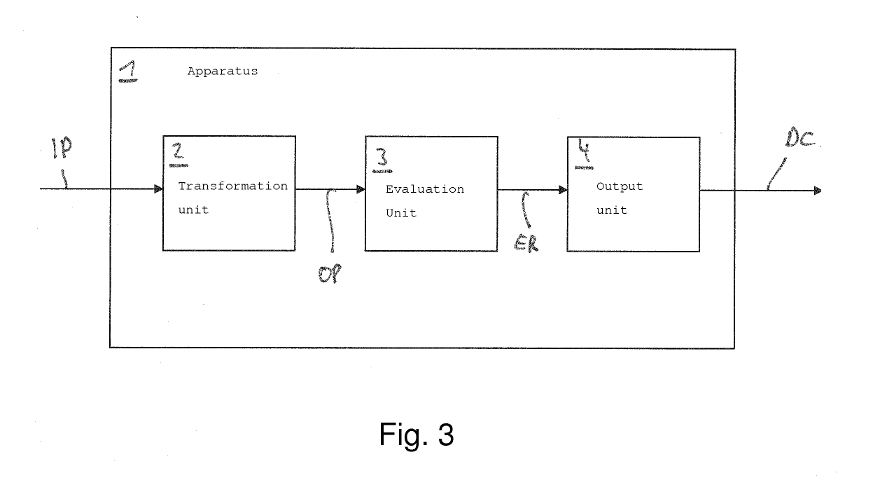

FIG. 3 shows a block diagram of an apparatus 1 for inspection of at least one device control instruction DCI executed by a device according to an embodiment. The apparatus 1 comprises a transformation unit 2 for transforming at least one provided input parameter IP into at least one provided output parameter OP by executing a device control instruction DCI. Apparatus 1 further comprises an evaluation unit 3 for evaluating a measured capability value CV of the device, wherein the capability value CV describes a performance parameter of the device executing the device control instruction DCI. The apparatus 1 has an output unit 4 for outputting the device control instruction DCI in case a specified evaluation result is determined.

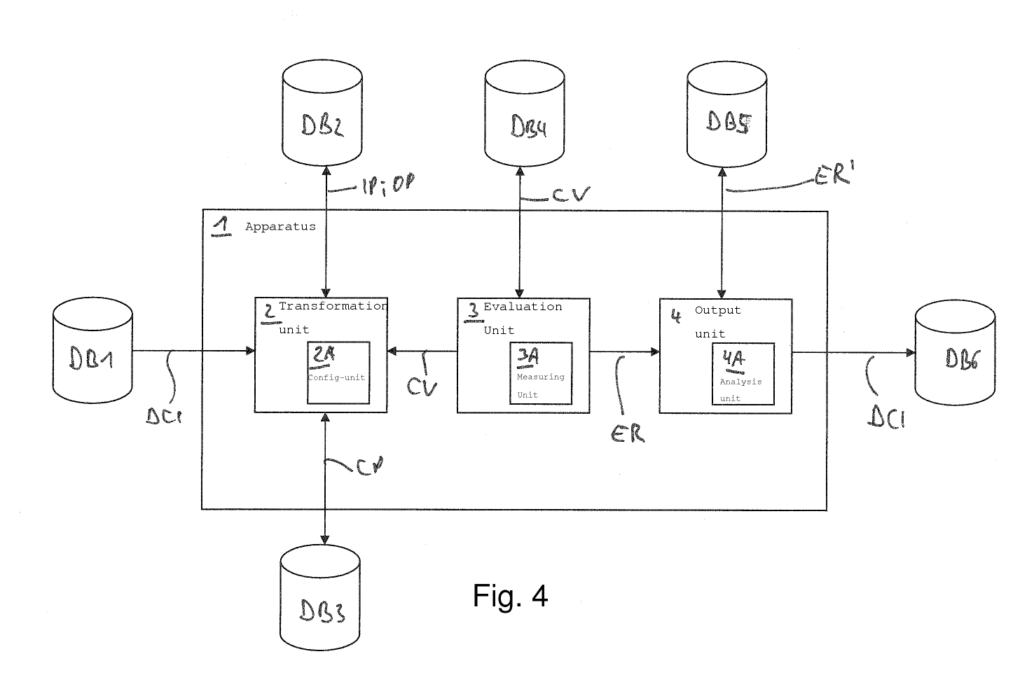

FIG. 4 shows a detailed block diagram of an apparatus 1 for inspection of at least one device control instruction DCI according to an embodiment and differs from the apparatus 1 as shown in FIG. 3 as follows.

In the present embodiment shown in FIG. 4 the transformation unit 2 for transforming at least one provided input parameter PI into at least one provided output parameter OP communicates with a first storage device DB1. The storage device DB1 stores a variety of device control instructions DCI, from which at least one is selected by the transformation unit 2.

A second storage device DB2 is adapted to provide at least one input parameter IP and at least one output parameter OP. In the present embodiment the input parameters indicate an actual situation of a project, while the output parameters indicate a desired outcome of that project. The project may for instance comprise manufacturing of products and/or assembling of components. The output parameters can for example describe a time duration, which is required to perform that project. Performing the project comprises accomplishing device control instructions DCI and especially several device control instructions DCI. These instructions can be derived from other application domains than operating a device. For instance an algorithm is executed on a further machine to execute at least one control instruction. A control instruction is generally suitable for transforming one state into another state. Such a state can describe an operation mode of a machine and/or the first state of a project into a second state of said project.

For performing at least one device control instruction DCI configuration parameters CP can be used for adapting the device control instructions DCI. These configuration parameters CP can be provided by a further storage device DB3. For adapting the device control instructions DCI and/or configuring said device control instructions DCI a configuration unit 2A is provided according to the present embodiment.

While the transformation unit 2 executes the device control instruction DCI the evaluation unit 3 measures at least one capability value CV. For measuring the capability value CV the measuring unit 3A is provided, which is e.g. be formed by a sensor. The measured capability values CV are stored in a further storage unit DB4. The storage unit DB4 can act as a logging device.

The measured capability values CV are evaluated by the evaluation unit 3 and the respective evaluation result ER is provided to the output unit. The output unit 4 comprises an evaluation result analysis unit 4A, which is designed to determine, whether a specified evaluation result ER′ is reached, while transforming the at least one provided input parameter IP into at least one provided output parameter OP. For receiving the specified evaluation result ER′ the analysis unit 4A communicates with a further storage device DB5. In case the specified evaluation result ER′ is reached by the actually derived evaluation result ER the output unit 4 stores the respective device control instruction DCI, which is received from the transformation unit 2, in a further storage device DB6. The storage device DB6 may for instance be comprised in a further post processing unit, which performs additionally operations on said device control instruction DCI.

The storage devices DB1, DB2, DB3, DB4, DB5, DB6 can be accessed via a network, the network comprising further network components, such as routers, switches, servers and network cards and may furthermore be accessed wirelessly or via cable. It may also be of advantage that said storage devices DB1, DB2, DB3, DB4, DB5, DB6 communicate with each other or are formed by one single storage device.

The proposed system uses a quantitative model of input, process areas and outcomes interrelations. For this model a set of goals for the outcomes can be specified, for instance by output parameters OP. Using this model the system uses a systematic search to find the optimal selection of inputs to reach the desired goals. The systematic search can be based on optimizing a cost function, for instance minimizing a cost function, which may be implemented by at least one device control instruction DCI. The cost function can be a weighted sum of the inputs, which may also be referred to as a cost of an improvement strategy.

The goals for the outcomes can provide constraints for the search or optimization process. The constraints can be integrated in the cost function as a penalty function. The analysis of the constraints can be based on a forward simulation, which yields the outcomes for a specific set of inputs. These outcomes can be compared to the goals. A time information, such as a number of time steps for the forward simulation, can be arbitrarily chosen enabling the computation of short long or long term strategies. The inputs can be defined as constant for the whole improvement period or the inputs at each time step can be optimized separately or certain combinations of inputs can be optimized. Then additional features or parameters and variables can be defined as intervals to reflect the inherent uncertainty. In this case, all computations are based on interval analysis. For the goals it can be specified, how they relate to the resulting interval, such as whole interval meets goal, midpoint meets goal, just one point meets goal.

Hence, a combination of a quantitative process simulation model, the systematic search and optimization techniques to automatically find and compare efficient improvement strategies are provided. Furthermore, a combination of the described method with interval arithmetic enabling a search or optimization approach under uncertainty is of advantage.

What is claimed is:

1. A method for inspecting at least one device control instruction, comprising the steps of:
transforming at least one provided input parameter into at least one provided output parameter by executing a device control instruction;
evaluating a measured capability value of said device, said capability value describing a performance parameter of said device executing said device control instruction; and
outputting said device control instruction in case a specified evaluation result is determined.

2. The method according to claim 1, wherein said device control instruction comprises at least one of a group of instruction specifications, said group consisting of: a device control instruction configuration, a parameterization of at least one device control instruction, a formal model, an algorithm, a differential equation, a device specification, a diagram and an alphanumerical device control instruction description technique.

3. The method according to claim 1, wherein evaluating said measured capability value is performed according to a stored capability evaluation metric.

4. The method according to claim 3, wherein said stored capability evaluation metric comprises at least one of a group of evaluation functions, said group consisting of: a cost function, a penalty function and an evaluation function.

5. The method according to claim 1, wherein said measured capability value is provided according to at least one of a group of provision techniques, said group consisting of: reading out a sensor, reading out a storage unit, estimation of said capability value, approximation of said capability value and calculation of said capability value.

6. The method according to claim 1, wherein at least one of said provided input parameters is weighted with a weighting factor.

7. The method according to claim 6, wherein said weighting factor indicates at least one of a group of input features, said group consisting of: a relevance of one input parameter that regards at least one further input parameter and a probability of an occurrence of at least one input parameter.

8. The method according to claim 1, wherein at least a selection of said provided input parameters is adapted before performing the step of transforming at least one provided input parameter into at least one provided output parameter.

9. The method according to claim 1, wherein at least a selection of said provided input parameters is transformed into said provided at least one output parameter.

10. The method according to claim 1, wherein at least one of a group of parameters is assigned an alphanumerical value, said group consisting of: said at least one provided input parameter and said at least one output parameter.

11. The method according to claim 10, wherein said alphanumerical value is defined as a function of a numerical interval.

12. The method according to claim 1, wherein said device control instruction describes at least one of a group of dependencies, said group consisting of: a temporal dependency, a structural dependency, a logical dependency, a dependency between at least two units of said device, a dependency between at least two activities of a process definition and a dependency between at least two parameters.

13. An apparatus for inspection of at least one device control instruction comprising:
a transformation unit for transforming at least one provided input parameter into at least one provided output parameter by executing a device control instruction;
an evaluation unit for evaluating a measured capability value of said device, said capability value describing a performance parameter of said device executing said device control instruction; and
an output unit for outputting said device control instruction in case a specified evaluation result is determined.

14. A computer program product comprising a computer readable medium comprising instructions which when executed on a computer perform the following steps:
transforming at least one provided input parameter into at least one provided output parameter by executing a device control instruction;
evaluating a measured capability value of said device, said capability value describing a performance parameter of said device executing said device control instruction; and
outputting said device control instruction in case a specified evaluation result is determined.

15. The computer program product according to claim 14, wherein said device control instruction comprises at least one of a group of instruction specifications, said group comprising: a device control instruction configuration, a parameterization of at least one device control instruction, a formal model, an algorithm, a differential equation, a device specification, a diagram and an alphanumerical device control instruction description technique.

16. The computer program product according to claim 14, wherein evaluating said measured capability value is performed according to a stored capability evaluation metric.

17. The computer program product according to claim 16, wherein said stored capability evaluation metric comprises at least one of a group of evaluation functions, said group comprising: a cost function, a penalty function and an evaluation function.

18. The computer program product according to claim 14, wherein said measured capability value is provided according to at least one of a group of provision techniques, said group comprising: reading out a sensor, reading out a storage unit, estimation of said capability value, approximation of said capability value and calculation of said capability value.

19. The computer program product according to claim 14, wherein at least one of said provided input parameters is weighted with a weighting factor.

20. The computer program product according to claim 19, wherein said weighting factor indicates at least one of a group of input features, said group comprising: a relevance of one input parameter that regards at least one further input parameter and a probability of an occurrence of at least one input parameter.

21. The computer program product according to claim 14, wherein at least a selection of said provided input parameters is adapted before performing the step of transforming at least one provided input parameter into at least one provided output parameter.

21. The computer program product according to claim 14, wherein at least a selection of said provided input parameters is transformed into said provided at least one output parameter.

22. The computer program product according to claim 14, wherein at least one of a group of parameters is assigned an alphanumerical value, said group comprising: said at least one provided input parameter and said at least one output parameter.

23. The computer program product according to claim 22, wherein said alphanumerical value is defined as a function of a numerical interval.

24. The computer program product according to claim 14, wherein said device control instruction describes at least one of a group of dependencies, said group comprising: a temporal dependency, a structural dependency, a logical dependency, a dependency between at least two units of said device, a dependency between at least two activities of a process definition and a dependency between at least two parameters.
